(19) United States
(12) Patent Application Publication
(10) Pub. No.: US 2026/0095058 A1
(43) Pub. Date: Apr. 2, 2026

(54) RETAIL ENVIRONMENT MONITORING DEVICE POWERED BY AMBIENT ENERGY

(71) Applicants: Durlabh Jain, Ashburn, VA (US); Marko Zeljko Grujic, Belgrade (SR)

(72) Inventors: Durlabh Jain, Ashburn, VA (US); Marko Zeljko Grujic, Belgrade (SR)

(21) Appl. No.: 18/902,129

(22) Filed: Sep. 30, 2024

(51) Int. Cl. H02J 7/00; H02S 10/40; H02S 40/38

(52) U.S. Cl. CPC H02J 7/82; H02J 7/40; H02J 7/96; H02S 10/40; H02S 40/38

(57) ABSTRACT

A retail environment monitoring device includes an ambient environment sensor; a communications module; a rechargeable battery; a voltage sensor circuit; and an ambient energy harvester. The communications module receives data from the sensor. The battery is connected to the sensor and the communications module. The voltage sensor circuit monitors the charge level of the battery. The ambient energy harvester recharges the battery using ambient energy, such as artificial light.

### BACKGROUND OF THE INVENTION

The present invention relates to a retail environment monitoring device and, more particularly, to a rechargeable monitoring device powered by ambient energy.

Consumer packaged goods (CPG) companies manufacture products and sell them in third party retail locations. Stock monitoring and controlling environmental conditions, such as temperature, humidity, and light in these retail store environments is problematic. The manufacturer must be able to monitor the stock and its environmental conditions without depending on retailer-provided facilities such as electricity. Running electrical power from the electrical grid specifically for the manufacturer's use is impractical.

There are a lot of commercially available battery-operated devices that may be used for stock monitoring. However, they usually require frequent recharging using an external power source or battery replacement. Moreover, battery operated devices have a limited battery life-especially if they contain cameras or Wi-Fi™/Cellular connectivity. Commercially available solar powered devices generally do not work well indoors. Some devices use wireless charging, but they still depend on readily available electricity and a receiver/transmitter module.

As can be seen, there is a need for battery-operated stock monitoring devices with extended functionality in a retail environment, even without direct sunlight.

### SUMMARY OF THE INVENTION

In one aspect of the present invention, a retail environment monitoring device comprises an ambient environment sensor; a communications module operative to receive data from the ambient environment sensor; a rechargeable battery electronically communicating with the ambient environment sensor and the communications module; a voltage sensor circuit operative to monitor a charge level of the rechargeable battery; and an ambient energy harvester configured to recharge the rechargeable battery using ambient energy.

The self-contained retail monitoring device disclosed herein has solar panels to charge its batteries in indoor conditions, generating enough charge to keep the device running for a long duration with efficient power management.

These and other features, aspects and advantages of the present invention will become better understood with reference to the following drawings, description, and claims.

### BRIEF DESCRIPTION OF THE DRAWINGS

FIG. 1 is a front perspective view of a device according to an embodiment of the present invention;

FIG. 2 is another front perspective view thereof;

FIG. 3 is a block diagram thereof;

FIG. 4 is a schematic view of the main board thereof; and

FIG. 5 is a schematic view of the power supply thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a battery-operated retail environmental monitoring device that recharges from environmental light such as light within a retail store/refrigerator, etc.

The monitoring unit may have at least one sensor selected from the group consisting of: temperature sensor, humidity sensor, light intensity/luminosity sensor, camera(s), and any combination thereof. The monitoring unit utilizes a rechargeable battery operative to capture energy from the environment—specifically from ambient light—for long life. Our device is expected to utilize less power than it generates in normal operating conditions of a retail environment such as refrigerator, coolers, chillers and even ambient shelves to keep going for at least 3 years. It can be used to increase battery life in indoor conditions where artificial light is strong enough to provide charging.

Since solar panels are not very effective in artificial light, the solar panels are configured to provide enough voltage and current to keep the unit charged/powered for a long term. The battery should always be sufficiently charged with the present system. When voltage is too high, limiters protect the circuitry.

In some embodiments, the device may include one or more peripherals for retail environment monitoring, selected from the group consisting of a microcontroller unit (MCU), a triggering circuit, and a communication module such as a Global System for Mobile Communication (GSM, a digital mobile network) module.

Peripheral systems in the device are triggered based on conditions set in the device. A trigger mechanism that is sensitive to vibration powers on the main MCU and limits the discharge of the battery. On vibration, the trigger mechanism starts a predefined scenario in the MCU. If the voltage provided by the ambient energy harvesters is above predefined level, the charging circuit will charge the battery.

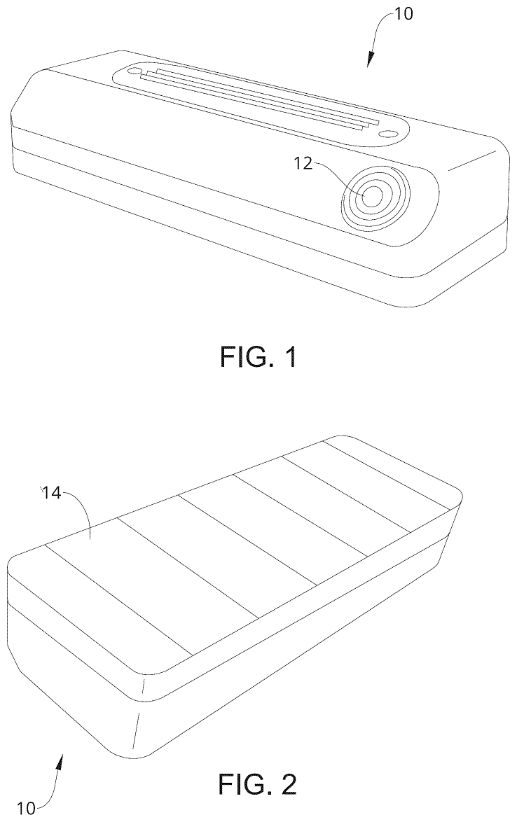

Referring to FIGS. 1-5, FIGS. 1-2 illustrate a retail environment monitoring device 10 according to an embodiment of the present invention, including a wakeup camera 12 and solar panels / ambient energy harvesters 14.

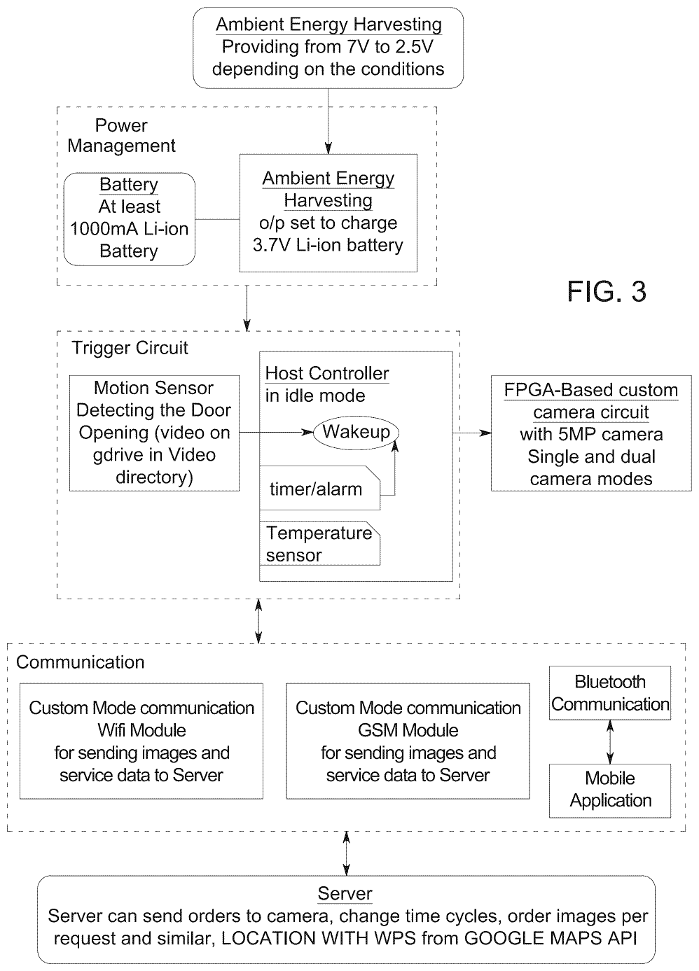

In an example disclosed in FIG. 3, the solar panels or ambient energy harvesters 14 may produce 7 volt (V) to 2.5V from ambient light, depending on the conditions, to charge a 3.7V, at least 1,000 mA, lithium (Li)-ion battery via a charging circuit. A trigger circuit, comprising a motion sensor that detects a door opening, wakes up a Host controller or MCU from idle mode. The wake-up function alternatively or in addition may be triggered by a timer/alarm and/or a temperature sensor. The host controller operates a field-programmable gate array (FPGA)-based custom camera circuit with synchronous dynamic random-access memory (SDRAM) and at least one 5 MP camera. The host controller may also activate a custom mode communication Wi-Fi™ wireless network module and/or GSM module operative to send images and service data to a server via a mobile application using Bluetooth™ short-range wireless communication. The server may send orders to the camera, change time cycles, and order images per request and the like using a location identified with Wi-Fi™ Protected Setup (WPS) from a GOOGLE MAPS Application Programming Interface (API).

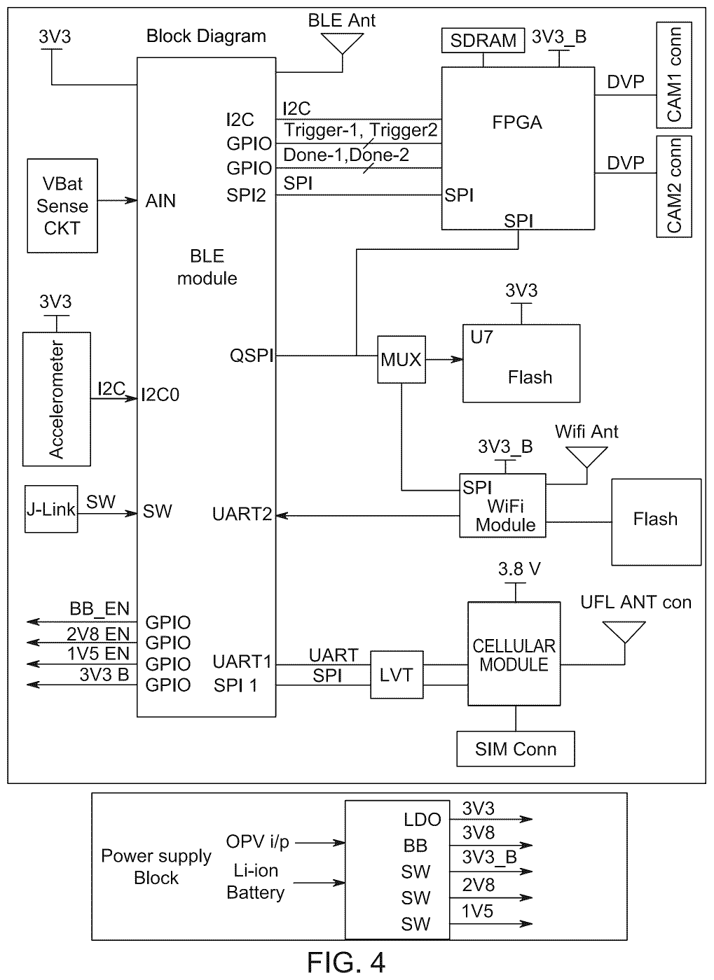

Turning to FIG. 4, a Voltage of the battery (VBat) sensor circuit, an accelerometer, and camera(s) (CAM1 conn, CAM2 conn) feed signals to a Bluetooth™ low energy (BLE) module having a BLE antenna. A Quad Serial Peripheral Interface (QSPI) delivers output from the BLE module to a flash device via a multiplexer (MUX). A Wi-Fi™ Module with an antenna and Flash device receives signal from the MUX and forwards signal to the BLE module via a driver. The device communicates with a cellular module having a subscriber identity module (SIM) connection and an ultra-small Wi-Fi™ antenna connector (UFL ANT con). The system is fed power from a power supply block including organic photovoltaic (OPV) and Li-ion battery power.

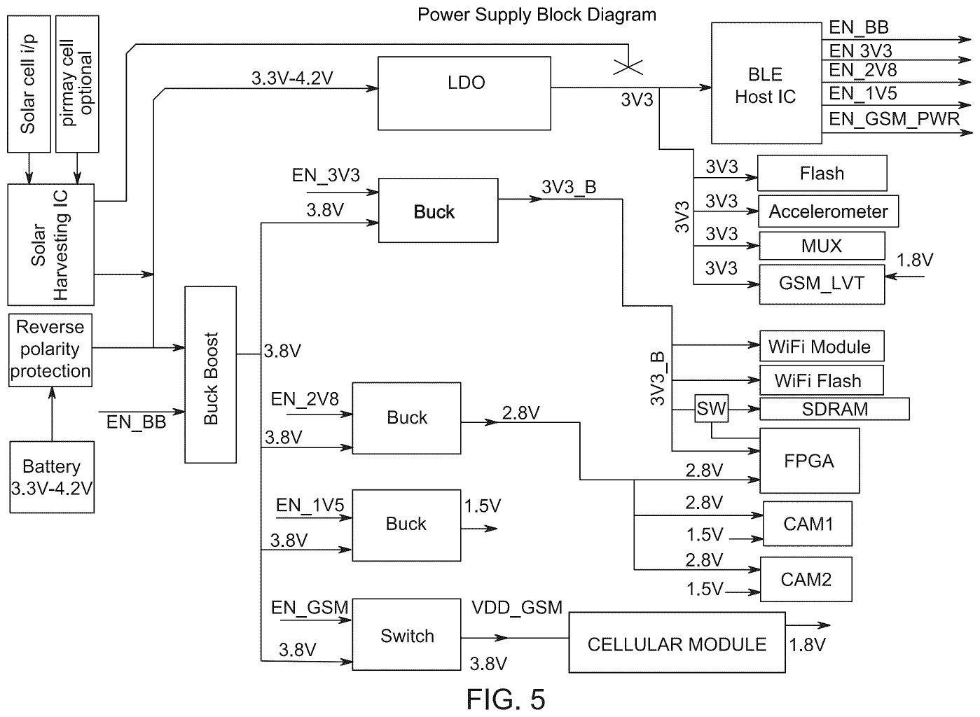

As shown in FIG. 5, a solar cell and an optional primary cell feed a solar harvesting integrated circuit (IC) which delivers 3.3V-4.2V through a low-dropout (LDO) regulator to a BLE host integrated circuit (IC), a flash device, accelerometer, MUX, and GSM Level Translator (LVT). The battery delivers 3.3V-4.2V through a reverse polarity protection component to a buck boost (DC-DC converter and transformer) which routes a 3.8V signal to several bucks in parallel and a switch. The bucks feed the Wi-Fi™ module and flash device, SDRAM, FPGA, and both cameras. The switch feeds the cellular module.

It should be understood, of course, that the foregoing relates to exemplary embodiments of the invention and that modifications may be made without departing from the spirit and scope of the invention as set forth in the following claims.

What is claimed is:

1. A retail environment monitoring device, comprising:
an ambient environment sensor;
a communications module operative to receive data from the ambient environment sensor;
a rechargeable battery electronically communicating with the ambient environment sensor and the communications module;
a voltage sensor circuit operative to monitor a charge level of the rechargeable battery; and
an ambient energy harvester configured to recharge the rechargeable battery using ambient energy.

2. The retail environment monitoring device of claim 1, wherein the ambient environment sensor is selected from the group consisting of a temperature sensor, a humidity sensor, a light intensity sensor, a luminosity sensor, a camera, an accelerometer, a voltage sensor, and any combination thereof.

3. The retail environment monitoring device of claim 2, wherein the camera is a wakeup camera.

4. The retail environment monitoring device of claim 1, wherein the ambient energy harvester is solar panel configured for use in artificial light.

5. The retail environment monitoring device of claim 1, wherein the device further comprises a peripheral device selected from the group consisting: of a microcontroller unit, a trigger circuit, a communication module, and any combination thereof.

6. The retail environment monitoring device of claim 5, wherein the trigger circuit senses vibration and activates instructions stored on the microcontroller unit.

7. The retail environment monitoring device of claim 5, wherein the trigger circuit comprises a component selected from the group consisting of: a timer, an alarm, a temperature sensor, and any combination thereof.

8. The retail environment monitoring device of claim 5, wherein the trigger circuit comprises a motion sensor operative to activate a host controller when the motion sensor senses motion.

9. The retail environment monitoring device of claim 8, wherein the host controller operates a field-programmable gate array-based camera circuit with synchronous dynamic random-access memory and at least one camera.

10. The retail environment monitoring device of claim 1, wherein the communications module is operative to communicate wirelessly with a server.

11. The retail environment monitoring device of claim 1, further comprising a multiplexer and a flash device electronically communicating with a low energy short-range wireless interconnection host integrated circuit (IC), a field-programmable gate array (FPGA), and wireless network module by way of the multiplexer.
